(19) United States
(12) Patent Application Publication
(10) Pub. No.: US 2016/0192202 A1
(43) Pub. Date: Jun. 30, 2016

(54) Methods And Apparatus For Small Cell Deployment In Wireless Network

(71) Applicants: ALCATEL-LUCENT USA INC., Murray Hill, NJ (US); ALCATEL LUCENT, Boulogne-Billancourt (FR)

(72) Inventors: Doru Calin, Manalapan, NJ (US); Aliye Ozge Kaya, Chatham, NJ (US); Denis Rouffet, Boulogne-Billancourt (FR)

(73) Assignees: ALCATEL LUCENT, Boulogne-Billancourt (FR); ALCATEL-LUCENT USA INC., Murray Hill, NJ (US)

(21) Appl. No.: 14/587,118

(22) Filed: Dec. 31, 2014

(51) Int. Cl. H04W 16/18

(52) U.S. Cl. CPC H04W 16/18; H04W 84/045

(57) ABSTRACT

A method of small cell deployment is performed in response to an initialization request or a performance alarm. The method includes selecting an initial number (N) of small cell candidate locations of one or more feasible small cell locations for small cells on a three dimensional grid of nodes representation of an area of interest and determining, feasible M-sized small cell tuples having small cells that do not conflict with each other, wherein M has an initial value less than or equal to N. The method also computes at least one performance Key Performance Indicator (KPI) for a subset of the feasible M-sized small cell tuples, and searches for a first tuple of the subset of the feasible M-sized small cell tuples, the at least one performance KPI of the first tuple satisfying one or more constraints on the small cell deployment.

### BACKGROUND

1. Field

This application relates generally to communication systems, and, more particularly, to small cell deployment in wireless communication systems.

2. Related Art

Current legacy wireless communication technologies based on macro-cellular technologies and Distributed Antenna Systems (DAS) are either limited in their ability to scale with increasing traffic demands or cannot track/adapt to dynamic traffic fluctuations. In certain circumstances, these technologies are not economically attractive either.

Small cells have been proposed as an added layer (overlay) to “fill gaps” and to add coverage/capacity whenever needed within a wireless communication system. Currently, the deployment of small cells is rather “surgical” in nature; operators identify areas of unsatisfactory performance in their macro network, and may decide to insert a small cell on a case by case basis for coverage/capacity enhancements. This process has many manual steps, takes a long time, and lacks adaptation to fluctuations in network conditions.

Small cells are expected to be the main driver for capacity solutions to cope with the anticipated increase in the traffic volume within wireless communication systems. However, the deployment of small cells, in particular in urban areas, is a challenging task.

### SUMMARY

The answer to the question of efficient (e.g., high performance, cost optimization, and the like) deployment of small cells within a real three dimensional (3D) environment is largely open and unanswered. Hundreds of low power small cells may need to be deployed in a large area in most cost-effective way (e.g., minimizing the number of sites) while yielding a required Quality of Experience (QoE) for a large percentage of users and meeting other Key Performance Indicator (KPI) thresholds. Thus, there is a need for an intelligent, self-adaptive, and self organizing deployment of small cells.

Accordingly, provided herein are method, apparatus and system for deployment (e.g., optimal deployment) of small cells to deliver a desirable QoE to users within real operational environments. An optimal deployment may be a deployment that fulfills requirements for optimal system performance and cost effectiveness, as further elaborated upon in the detailed description that follows. In one embodiment, provided is an optimal solution for deploying small cells; that is, the provided solution determines the minimum number of small cells and the locations of the minimum number of small cells within a real 3D environment to provide wireless services for a target area while fulfilling a set of KPIs. One or more embodiments of the invention may be applied to difficult areas to serve, such as areas within buildings (i.e., indoor), where high data rates are likely to be required.

According to the methodology described and provided herein, one embodiment includes, in response to an initialization request or a performance alarm, selecting, at a network entity, an initial number (N) of small cell candidate locations of one or more feasible small cell locations for small cells on a three dimensional grid of nodes representation of an area of interest; determining, at the network entity, feasible M-sized small cell tuples having small cells that do not conflict with each other, wherein M has an initial value less than or equal to N; computing, at the network entity, at least one performance Key Performance Indicator (KPI) for a subset of the feasible M-sized small cell tuples; searching for a first tuple of the subset of the feasible M-sized small cell tuples, the at least one performance KPI of the first tuple satisfying one or more constraints on the small cell deployment; when the searching for the first tuple does not indicate a feasible small cell deployment, incrementing , at the network entity, the initial value of M; and when the searching for the first tuple indicates a feasible small cell deployment, preparing , at the network entity, a software patch configuration for one or more small cells of the feasible small cell deployment.

In another embodiment, the initial number (N) of small cell candidate locations is a predetermined number or one.

In another embodiment, the method includes forming the three dimensional grid of nodes representation of the area of interest, and determining the one or more feasible small cell locations on the three dimensional grid of nodes representation.

In another embodiment, the method includes receiving traffic information updates, and determining that the initialization request or the performance alarm was triggered.

In another embodiment, the method includes transmitting the software patch configuration to a first small cell of the feasible small cell deployment.

In another embodiment, the software patch configuration indicates at least one of power level, beam shape, tilt or azimuth for a first small cell of the feasible small cell deployment.

In another embodiment, the method includes configuring a first small cell of the feasible small cell deployment with one or more parameter values specified in the software patch configuration.

In another embodiment, the method includes the determining the feasible M-sized small cell tuples having small cells that do not conflict with each other includes performing an exhaustive search algorithm, performing an algorithm to reduce a search space, or performing a binary integer program.

In another embodiment, the searching for the first tuple of the subset of the feasible M-sized small cell tuples includes determining a plurality of tuples of the subset of the feasible M-sized small cell tuples which satisfy the one or more constraints on the small cell deployment, and selecting as the first tuple the one of the plurality of tuples of the subset of the feasible M-sized small cell tuples having best performance KPIs.

In another embodiment, the at least one performance KPI is at least one of the group consisting of cell edge Signal to Interference and Noise Ratio (SINR), average SINR, user cell edge throughput, and average user throughput.

In another embodiment, a device includes a processor and an associated memory, with the processor configured to perform the method of any embodiment.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention.

FIGS. 1a and 1b show the three dimensional (3D) plan of a mid-size office building, including its interior, exterior and surroundings.

FIG. 2a illustrates an example of a 3D Grid of nodes overlaid on top of a 3D environment.

FIG. 2b illustrates an example of a 3D Grid of nodes overlaid with an area of interest.

FIG. 3 is an example flowchart of a high level description of the steps of an example method according to the principles of the invention.

FIGS. 4a-4d are a time series of illustrations that exemplify the method according to the principles of the invention.

FIG. 5 is a visual representation of the messages between small cells and the network entity which hosts the methodology for real time small cells deployment optimization according to the principles of the invention.

FIGS. 6 and 7 illustrate the state of a small cells system providing wireless services (coverage & capacity) to an area of traffic concentration at two different time instances T1 and T2.

FIG. 8 illustrates a portion of an Evolved Packet System (EPS) in which embodiments of the invention may be deployed.

FIG. 9 depicts a high-level block diagram of a computer suitable for use in performing the operations and methodology described herein.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The principles of the invention may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

For simplicity and consistency, the technological terms used herein refer to the Long Term Evolution (LTE) technology, but can be generalized for any wireless technology. The terms small cell and nodes are synonymous.

Method, apparatus and system are provided for deployment (e.g., optimal deployment) of small cells to deliver a desirable QoE to users within real operational environments. An optimal deployment may be a deployment that fulfills requirements for system performance and cost effectiveness. In one embodiment, an optimal deployment is a plan for deploying small cells, with the plan detailing a number of small cells and the locations of the number of small cells within a real three dimensional (3D) environment to provide wireless services to a target area while fulfilling a set of KPIs. The number of small cells may be the minimum number necessary to provide the desired level of service. One or more embodiments of the invention may be applied to difficult areas to serve, such as areas within buildings (i.e., indoor), where high data rates are likely to be required, or to outdoor areas subject to high traffic density, where many users are contending for wireless services.

One or more embodiments are utilized to determine the network configuration for small cells that adapts continuously to changes in traffic conditions. Further, the network configuration may be adapted to meet the target network performance and be realized with minimum cost. The configuration may include at least one of identification of a minimum number of active transmitters, power levels for active transmitters, or beam shape for active transmitters. The configuration may include, as well, tilts & azimuths for each beam; it may also include the maximum number of connections sustainable at a minimum target data rate to be supported/accepted by each beam.

An algorithm that implements a method according to the principles of the invention resides within a network entity that is integrated in the communication network (e.g., OAM center, cloud). The algorithm makes use of i) network configuration that is known at said network entity at any time; ii) traffic measurements that are available at said network entity and that are updated with a suitable time granularity (e.g., every X number of minutes, hours, or days, and the like).

The algorithm identifies possible candidate network configurations and converges to a particular network configuration (e.g., optimal network configuration) that will meet the required QoS and/or KPIs. The particular network configuration is pushed via network configuration updates to the network (e.g., through software patches containing network element/s configuration updates forwarded to network element/s (e.g., similar in certain aspects to updates performed on a smart phone)). The algorithm is performed iteratively, using the above steps, so as to continue to adapt to the network configuration for changing conditions and requirements. Note that, fully distributed forms of this algorithm could also be envisaged as implementation options in one embodiment, where small cells exchange the available information and converge to a new configuration after some trial/error steps. In another embodiment, hybrid forms of this algorithm, relying on a centralized entity, as described above, as well as on small cells exchanging available information, can be also envisaged as implementation options.

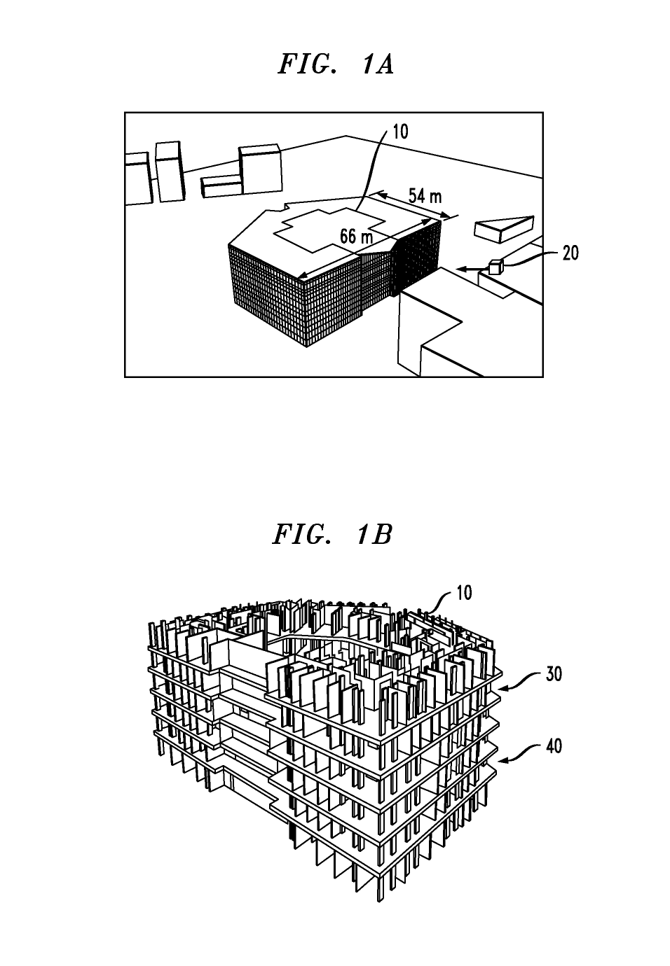

FIGS. 1a and 1b show the three dimensional (3D) plan of a mid-size office building, including its interior, exterior and surroundings. For a given area of interest, the algorithm for determining a deployment of small cells obtains for its use a 3D representation for simulation, including a specific area of interest and surrounding buildings. The 3D representation for simulation can be obtained by acquiring databases for the buildings with propagation characteristics for the materials of construction. For example, FIG. 1a shows the 3D plan of a mid-size office building 10, including its exterior and surroundings. Locations and dimensions of building in an area of interest can be acquired. For instance, one wall of building 10 is 66 meters while another wall I 54 meters. The location of a small cell 20 is marked with a cube and its direction represented with an arrow towards the middle entrance of the building 10.

The interior structure of the building 10 is illustrated in FIG. 1b. For example, the building 10 includes concrete floors 30 and has sheetrock walls and false ceilings 40 which engender a 14 dB loss per ceiling. Locations and dimensions of internal features of the building, as well as material propagation properties, may also be detailed in the 3D plan.

Note that, currently, such databases exist sporadically or they can be generated. It is expected that in the future, such databases of maps with building characteristics will be more largely available, as this is a big sector for future enterprise, and the majority of the traffic activity (e.g., 70%) is associated with indoor, requiring advanced knowledge of the building characteristics.

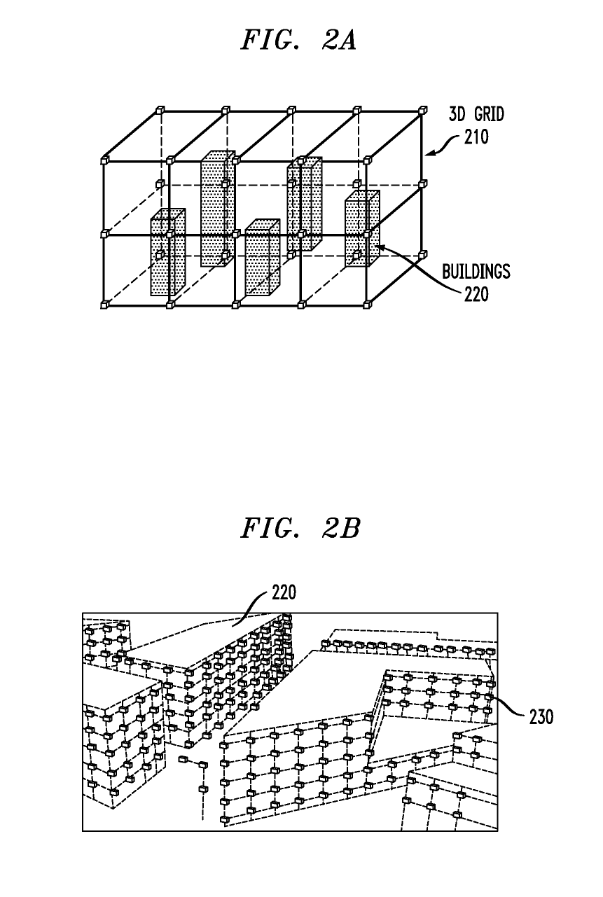

According to the methodology provided herein, a set of candidate locations for the potential serving nodes (e.g., small cell base stations or similar access nodes) that provide wireless connectivity to the end user terminals is identified. In one embodiment, the candidate locations are represented through a 3D grid of nodes 210. The grid can be represented by a giant cube that wraps up the entire area of interest for the analysis. Traffic activity is expected to be generated within the area of interest due to buildings 220 located within area of interest. Further, multiple parallel lines can be drawn on each face of the cube, with a parametric distance of choice between the parallel lines. FIG. 2a illustrates an example of a 3D Grid of nodes overlaid on top of a 3D environment. Each line crossing results in a potential candidate location for a serving node. The grid can be further densified by drawing additional parallel lines within the faces of the cube, starting from each potential candidate location for a serving node on the exterior faces of the cube (a line intersection being a potential candidate location for a serving node). Lines are used for illustration purposes in this example. One can use grids of any shape (e.g., spheres of various radius).

The candidate locations of the potential serving nodes can be further constrained by intersecting the grid of nodes with feasible placements on rooftops, facades or light poles, which excludes the unfeasible locations (e.g., points of no feasible attachments due to constraints in geometry, electricity, backhaul, etc). FIG. 2b illustrates an example of a 3D Grid of nodes overlaid with an area of interest. As illustrated, feasible locations for small cells 230 are shown on facades of buildings and light poles.

In one embodiment of this invention, the feasible candidate locations may be already provisioned with radio transmitters (small cells) equipped with the functionalities stipulated in this method. It is noted that cheaper radios with a split of functions between the RF at site locations (commodity hardware) in one hand, and baseband processing (algorithms and software) in a centralized location on the other hand may be utilized in one embodiment. In another embodiment of this invention, the 3D grid of nodes may contain locations where small cells were already deployed, as well as new potential/hypothetical locations. In the later case, if the outcome of the analysis indicates that such new potential locations benefit the overall system performance, wireless network operators may find incentives to equip those locations with radios.

The grid of serving small cell nodes may complement an existing wireless infrastructure (e.g., macrocells on the same technology or on a different technology serving the area of interest).

The method of small cell deployment disclosed in herein includes an algorithm that resides within a network entity that is integrated in the network (e.g., OAM center, cloud). The method of small cell deployment determines a particular deployment of small cell based on candidate locations of small cells.

Traffic patterns and potentially congested areas are known from the existing wireless deployments. For example, traffic may be measured continuously through various counters that are reported with certain time granularities. This traffic and congestion information can be reported to the network entity for small cell deployment via available network interfaces. The reporting time granularity can differ from counter to counter, that is some counters can be reported much more frequently than others, depending on the type of information. For instance, information that is used to assist the scheduling of the air-interface (e.g., radio metrics specific to user/s radio conditions) is usually required to be refreshed with a granularity in the order of msec in order to be exploited intelligently before becoming obsolete. Other information that relates to traffic volume aggregation (e.g., average number of connections established, other averages and the like) can be reported and refreshed less frequently (e.g., seconds or minutes interval).

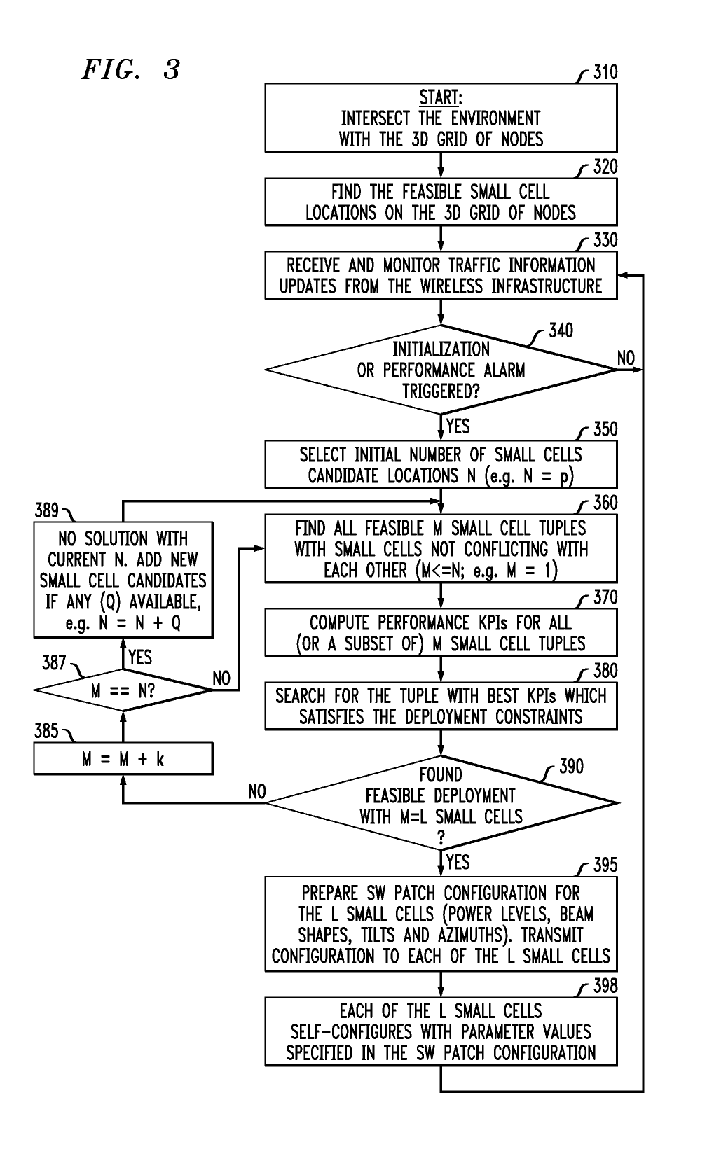

FIG. 3 is an example flowchart of a high level description of the steps of a method according to the principles of the invention. In operation 310, the method starts and intersects the environment (area of interest) with a 3D grid of nodes. See FIG. 2a. In operation 320, the method finds feasible small cell locations on the 3D grid of nodes. See FIG. 2b. In operation 330, the method receives and monitors traffic information updates from the wireless infrastructure.

At operation 340, the method determines whether there is an initialization request for small cell deployment or a performance alarm was triggered. A performance alarm may be triggered when a system performance threshold is violated. A performance alarm may be a predefined periodic alarm. If neither event has occurred, the method continues to receive and monitor traffic information updates until such event occurs. If an initialization request was received or a performance alarm was triggered, the method advances to operation 350 where an initial number of small cell candidate locations N are selected. The initial number of small cell candidate locations N may be a predetermined number (e.g., N=p). The initial number of small cell candidate locations may be one.

In operation 360, the method finds all feasible M small cell tuples with small cells not conflicting with each other. M is a subset of N (i.e., M<=N). M may have an initial value that is a predetermined value. M may have an initial value of one. Here the term M small cell tuple refers to a set of small cells of size M (M small cells in the set), where parameter settings leading to specific configurations of the tuple, such as power, beam pattern, tilt and azimuth may also be included for each small cell of the tuple. For example, assume that N =100. M is a subset of N, for example, assume that M is 20. Then, any set of 20 out of 100 small cells is a possible “tuple”. If M=2, tuple means double, and refers to any set of 2 small cells out of the total 100. If M=3, tuple means triple, and refers to any set of 3 small cells out of the total 100. Then once the value of M is selected, one can further create tuples of size M by setting power levels, antenna characteristics for each of the M-size small cells tuples which define a unique configuration for the tuple. For example, if M=2, and once a subset of 2 small cells is selected, further tuples of size 2 can be created by setting power levels, antenna characteristics for each small cell, thereby establishing a number of configurations for tuples which include the subset of 2 small cells. Some of these tuples may be free of conflict and others may have conflict.

In operation 370, the method computes performance KPIs for all (or a subset of) M small cell tuples.

In operation 380, the method searches for the tuple with the best KPIs which satisfies the deployment constraints.

In operation 390 the method determines whether a feasible deployment with L small cells is found. L is equal to M at this point in the methodology. If a feasible deployment is not found in operation 390, at operation 385, the method increments the initial value of M. At operation 387, the method determines whether M is equal to N; that is; the method determines whether all possible sized tuples up to N-sized tuples have been checked for a feasible small cell deployment. If all possible sized tuples up to N-sized tuples and hence all possible small cell deployments of the initial number of small cell candidate locations have not been checked, the method returns to operation 360.

If all possible sized tuples up to N-sized tuples and hence all possible small cell deployments of the initial number of small cell candidate locations have been checked, the method advances to operation 389. At operation 389, new small cell candidates, if any are available (e.g., Q new small cell locations), are added to the initial number of small cell candidate locations, N is incremented accordingly (N=N+Q) and the method return to operation 360. For example, new potential/hypothetical small cell locations may be added to the candidate locations. Then, if the portion of the methodology described with respect to operations 360-390 indicates that new potential/hypothetical small cell locations would benefit the overall system performance, wireless network operators can be informed of the desirability of equipping those locations with small cells.

If a feasible deployment is found in operation 390, at operation 395, the method prepares a software patch configuration for the L small cells (power level, beam shape, tilt and azimuth) and transmits the software patch configuration to the L small cells.

In operation 398, the L small cells self configure with parameter values specified in the software patch configuration and the method returns to receiving and monitoring traffic information updates from the wireless infrastructure at operation 330 while awaiting an initialization request or performance alarm trigger (operation 340).

In one embodiment, the methodology described at a high level in FIG. 3 selects a set of N potential candidate serving nodes from all possible serving nodes. Yet, in a preferred embodiment, the methodology starts with M, M<=N, as the smallest number of serving nodes that can be considered. That is, M>=1, and the initial value of M is the minimum value the methodology may start with. For each value of M there may be several network configurations to be considered; the order in which these several network configurations are evaluated may be either arbitrary or may follow some pre-determined criteria. For any selected number of M nodes, the methodology determines a system configuration which includes the transmit power levels at each of the M nodes, the antenna patterns (including beams shapes) at each of the M nodes, tilt and azimuth orientation of each beam. Subsequently, the methodology performs computation of at least one performance metric of interest to determine if a performance criterion is met. The performance criterion could be, for instance, a desirable threshold for cell edge Signal to Interference and Noise Ratio (SINR), or a desirable threshold for average SINR, or a desirable threshold for user cell edge throughput, or a desirable threshold for average user throughput—to name just a few. If the at least one performance criterion is satisfied, the corresponding system configuration becomes a solution. In one embodiment, the search of solutions for a desirable system configuration can be stopped at this point, once a first solution is found. In another embodiment, the search can continue for a more satisfying solution, depending on the acceptable tradeoff between system performance and cost. If the selected configuration does not fulfill the at least one performance metric, the methodology can consider other possible system configurations with M nodes. If none of the configurations with M nodes met the said performance criteria, one increments the number of nodes from M to M+k, where k>=1, and methodology proceeds to the search for an eventual solution with M+k nodes.

In one embodiment of the invention, the methodology from operation 360 to determine the feasible number of small cells, M, is an exhaustive search algorithm. In another embodiment, methodology employs another algorithm to reduce the search space, such as a binary integer program, as described below.

Binary Integer Program for Determining the Minimum Number of Small Cells Based on Coverage, Conflict and Interference Constraints:

The following optimization problem could be used to minimize the number of small cells “M” such that each location receives a strong signal from at least one small cell and a strong interfering signal from at most “y” other small cells, while none of the conflicting small cells are active together (two small cells are declared in conflict if, for instance, they create a level of interference to each other that is beyond a pre-determined threshold; conflict can be also caused by deployment constraints, such as available space, power, or backhauling availability, etc). The resulting “M” could be used as a starting point in the above algorithm.

min x^{T}x

s.t.

1≦Ax≦y

Cx≦0

xⱼ∈{0,1}

where x is the small cell selection vector and has the length equal to the sum of the number of candidate small cells and the number of already active small cells. The entries corresponding to the active small cells are set to 1, the others are variables. If the j'th transmitter is selected, x_j is set to 1, otherwise it is set to 0. The minimum number of small cells equals to the norm of x, i.e. M=x^{T}x.

A is the received power strength indicator matrix. A_ij=1 if the received power at the UE location i exceeds a given threshold, otherwise it is equal to 0.

y controls the number of strong interferers. y_i equals the maximum number of small cells having a signal exceeding a power threshold at the user i.

C is the conflict matrix. C_ij equals 1 if the transmitters i and j conflict based on any criteria, otherwise it is zero. Cx=0 enforces that none of the selected small cells conflict with each other.

When a solution is found, with for example M feasible serving nodes, a “software patch configuration” is prepared by the network entity. The software patch configuration includes the system configuration parameters for the M serving nodes. For each such serving node, specified is the transmit power level, the antenna patterns (including beams shapes), tilt and azimuth orientation of each beam of the antenna.

In one embodiment, for each individual node of the set of M serving nodes, the information pertaining to the configuration for a serving node can be transmitted to that serving node so the configuration may be implemented by the small cell. Note that the frequency of these updates may be at a highly macroscopic level (e.g., minutes/hours) compared to the resource allocation cycles (milliseconds). Also, since these are small configuration files, the volume of signaling generated by these updates is not significant. To avoid any concern related to potential increase in signaling, these notifications can be performed either simultaneously or sequentially in time with some time granularity. Upon reception of the said information, the individual node self-configures by adjusting to the parameters values specified in the software patch configuration for the said individual node. Yet, in another embodiment, the previous configuration of each affected node are stored in a memory device which pertains to the said affected node, or the previous configuration is stored in the network entity, from where it can be later downloaded at any time.

System performance is continuously monitored by the network entity. In case of an unexpected and unacceptable degradation in the system performance following an update on the system configuration, an alarm can be issued by the network entity to each of the nodes that were affected. Upon the reception of the said alarm, in one embodiment, the nodes revert to the previous configuration and the network continues to be monitored.

In one embodiment, the described methodology for computing the optimal system configuration can be repeated on a regular basis, with a certain pre-determined time interval. In another embodiment, the methodology can be invoked as soon as a performance alarm is triggered. The performance alarm may be caused/triggered each time a system performance threshold is violated. A performance alarm may also be caused/triggered by a predefined periodic alarm.

Furthermore, the user traffic is subject to fluctuations over time, and as such, small cell deployments need to quickly adapt to such changes in traffic patterns and distributions.

The techniques disclosed apply to both green and brown field deployments of small cells. The proposed method and apparatus monitor and process information about the environment, traffic and the QoE for the end users. The proposed method and apparatus then select and adjust the small cell system configuration based on traffic patterns and other environmental factors.

Referring again to FIG. 3, as a first step 310, the area of interest is intersected with a 3D grid as shown in FIG. 2b. The grids could contain potential candidate locations that are created according to some criteria, e.g., uniform or random spatial placement. The 3D grid can be of any shape and size. For illustrative purposes, FIGS. 2a-b illustrate rectangular grids with uniformly placed candidate locations.

Among the set of grid locations, the proposed method at step 320 selects the feasible candidate small cells based on known deployment constraints. At a given time, t, the method selects and activates the small cells yielding the minimum cost deployment to serve the current traffic (step 330) according to the following:

i: Set N as the minimum number of small cells to be deployed for the area of interest (step 350). At the minimum, N could be set to 1 initially and increased in steps gradually through an outer loop. N could be also preferably guessed through back of the envelope calculations, e.g., N=Number of users/maximum number of users per small cell, or can be determined solving an optimization problem based on cost, capacity and/or coverage constraints.

ii: Find all feasible M small cell-tuples without any conflicting small cells in the same tuple (M<=N) (step 360). That is, M>=1, and the initial value of M is the minimum value the methodology may start with (e.g., M=1 to start the incremental inner loop, but a higher value can be used). Hence, those tuples that contain conflicting small cells are excluded at this step in order to look for feasible solutions and reduce the search space. Two small cells are declared in conflict if, for instance, they create a level of interference to each other that is beyond a pre-determined threshold; conflict can be also caused by deployment constraints, such as available space, power, or backhauling.

iii: Compute the performance KPIs for each (or a subset) of the feasible M small cell-tuples (step 370).

iv: If there exists at least one small cell deployment fulfilling the required KPI constraints, stop the search (step 390) and choose the deployment with the best KPIs (step 380). Otherwise, increase M to M+k (step 385). Go back to the first step of the search (step 360) if small cell deployments including all small cells indentified by the initial number of small cell candidate locations have not been analyzed. (step 387). Otherwise (step 387), add additional small cell candidate locations to the search space (step 389) and return to the first step of the search (step 360).

v: Prepare a software patch configuration for the small cell deployment (step 395).

Subsequently, the method continues monitoring the traffic, changes in environmental conditions and users QoE (step 330). When at least a performance criterion is no longer met (e.g., QoE, spectral efficiency, and the like), trigger a reselection of small cells and/or tuning of critical parameters (e.g., power level, bandwidth, beam width, tilt, azimuth adjustment, etc.) (step 340).

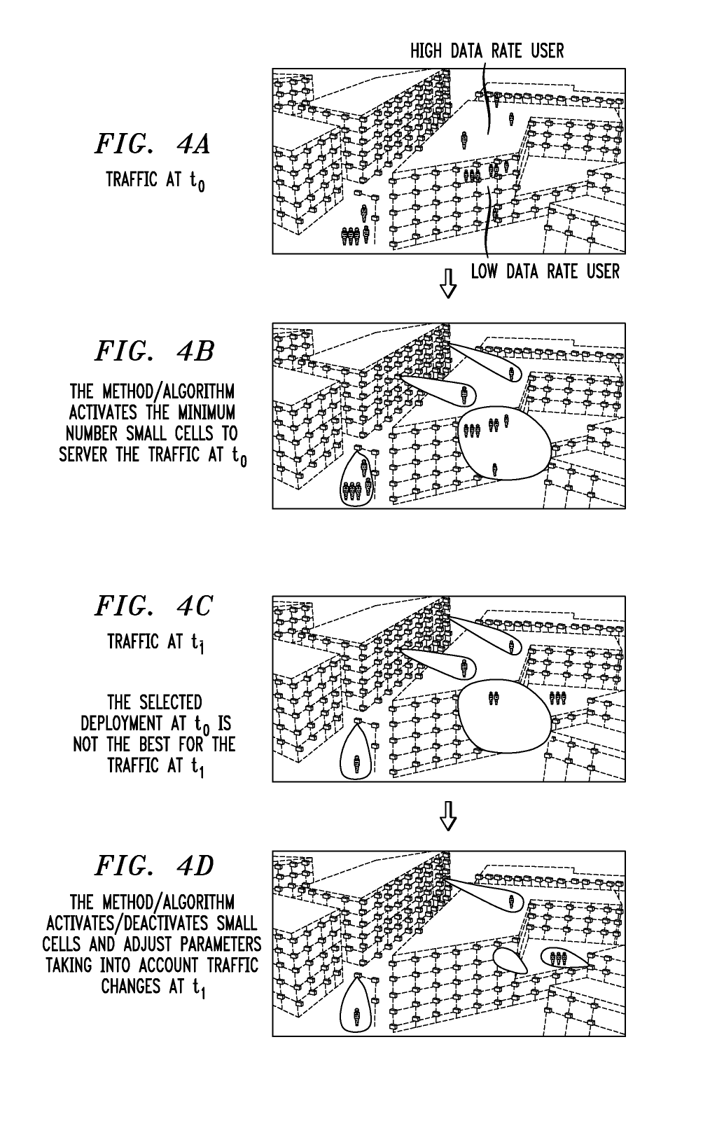

FIGS. 4a-4d are a series of illustrations that exemplify the method according to the principles of the invention. FIG. 4a illustrates users interposed on the FIG. 2 example 3D Grid of nodes overlaid with an area of interest. At time t₀, the users generate a level of traffic. Accordingly, at time t₀, the network node for small cell deployment according to the principles of the invention activates a number of the small cells to serve the corresponding traffic (e.g., the minimum number). As illustrated in FIG. 4b, a single small cell with a directive antenna pattern is dedicated to a single high data rate user. Another small cell with a much broader antenna pattern serves multiple low data rate users. There are many users being served by the small cell attached to the lamppost.

FIG. 4c illustrates the small cell deployment determined at time t₀ still in use at time t₁. Accordingly, the antenna patterns illustrated in FIG. 4b are again illustrated in FIG. 4c. However, as illustrated in FIG. 4c, at time t₁, the selected small cell deployment from t₀ is no longer the best for the traffic at t₁. For example, the high data rate user is no longer active and no user is being served at time tᵢ by the antenna pattern that previously served the high data rate user. In addition, at time t₁, some of the low data rate users have moved beyond the coverage area of the small cell with the broader antenna pattern. Further, fewer users are served by the small cell attached to the lamppost at time t₁. Based on these changes, the network node for small cell deployment triggers a system reconfiguration, which may result in a change in serving sites and/or adjustment of critical parameters of the active sites (e.g. power levels, radiating patterns of the antenna, and the like). The methodology described here activates/deactivates small cells and/or adjusts parameters taking into account traffic changes at time t₁. As illustrated in FIG. 4d, the narrow beam activated at t₀ to serve the high date rate user is deactivated at t₁. In addition, the broad beam pattern of the small cell serving the low data rate users in the building at time t₀ is made narrower since the users left in service contention at t₁ are less spatially dispersed. Further, another small cell is activated at time t₁ to serve users at a new location that was inactive at time t₀. Moreover, less bandwidth is allocated to the small cell at the lamppost and the beam shape and radiating power are adjusted according to the new user density. In this manner, the methodology according to the principles of the invention monitors and reselects the small cell deployment to meet the traffic demand.

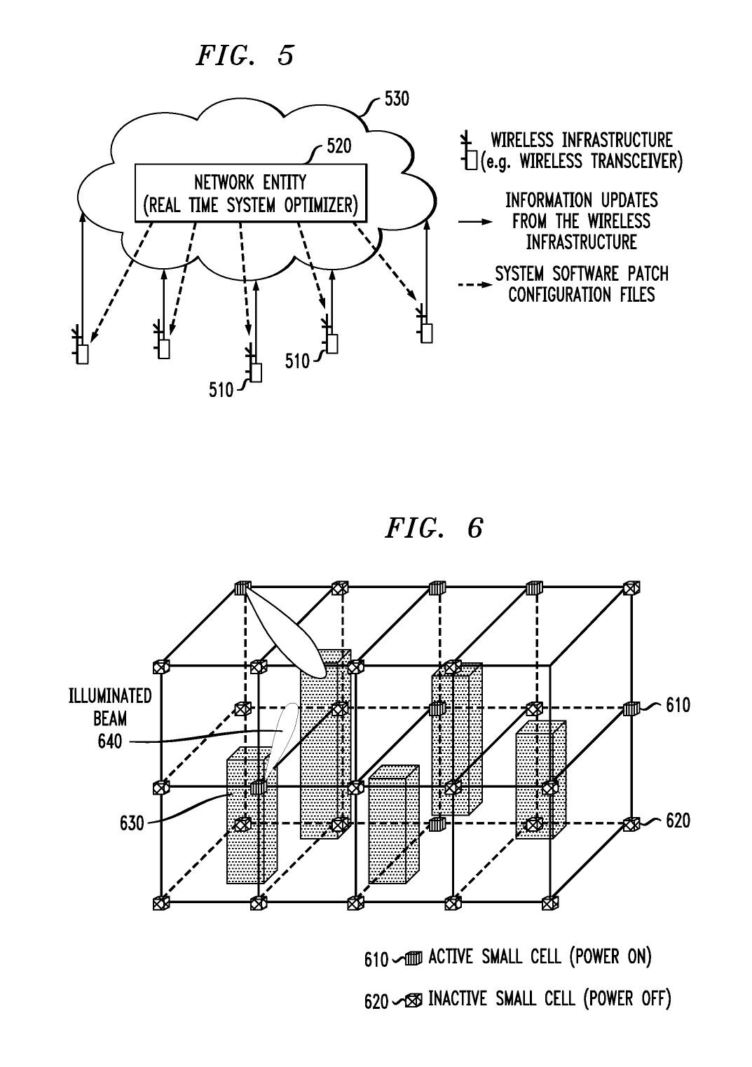

FIG. 5 is a visual representation of the messages between small cells and the network entity which hosts the methodology for real time small cells deployment optimization according to the principles of the invention. Small cells 510 are deployed in various locations in the environment. An algorithm that implements a method according to the principles of the invention resides within a network entity 520 that is integrated in the communication network 530 (e.g., OAM center, cloud). The network entity 520 has access to information concerning the deployment of the small cells and traffic measurements. The network entity 520 receives information updates from the wireless infrastructure via the wireless network 530. The network entity 520 provides system software patch configuration updates instructing updates to the small cell deployment to the small cells 510 via the wireless network 530.

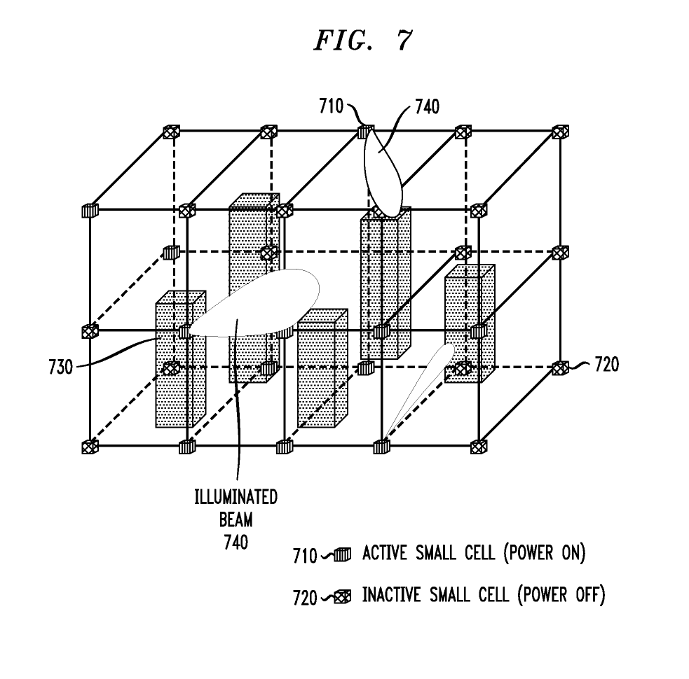

FIGS. 6 and 7 illustrate the state of a small cells system providing wireless services (coverage & capacity) to an area of traffic concentration at two different time instances T1 and T2. The vertical blocks 630, 730 are buildings, where end users require wireless services. At any one time, there are small cells that are active small cells with power on (610, 710) and inactive small cells with power off (620, 720). As the traffic pattern evolves over time, so does the system configuration and different antenna beams (640, 740) may be illuminated from time-to-time. Thus for example, as illustrated in FIG. 6, at T1 there are two active small cells shown radiating energy (illuminated beams 630) with the appropriate power and beam steering towards an area of traffic concentration. At T2, there is a different traffic concentration compared to T1, and consequently the small cells that used to provide service at T1 are no longer or differently required. Instead, as illustrated in FIG. 7, three other active small cells are configured with appropriate power and beam steering (illuminated beams 740) towards the new area/s of traffic concentration.

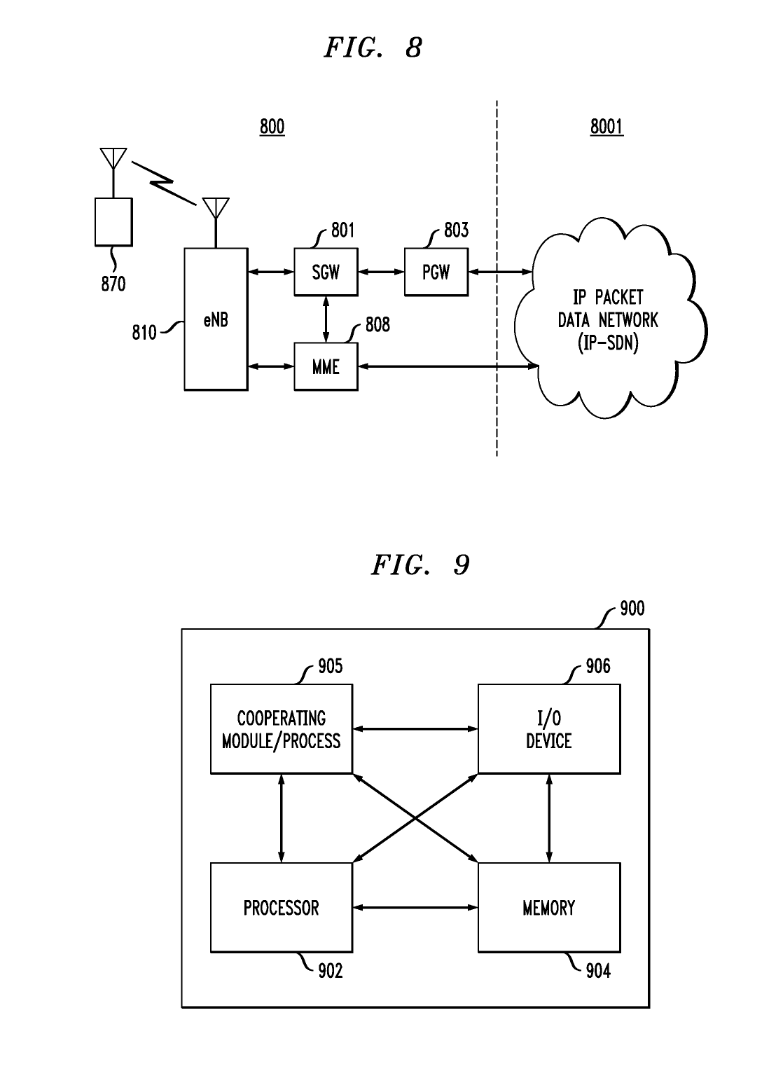

FIG. 8 illustrates a portion of an Evolved Packet System (EPS) in which embodiments of the invention may be deployed. The EPS includes an Internet Protocol (IP) Connectivity Access Network (IP-CAN) 800 and an IP Packet Data Network (IP-PDN) 8001. Referring to FIG. 8, the IP-CAN 800 includes: a serving gateway (SGW) 801; a packet data network (PDN) gateway (PGW) 803; a mobility management entity (MME) 808, and an eNB 810. Although not shown, the IP-PDN 8001 portion of the EPS may include application or proxy servers, media servers, email servers, etc.

Within the IP-CAN 800, the eNB 810 is part of what is referred to as an Evolved Universal Mobile Telecommunications System (UMTS) Terrestrial Radio Access Network (EUTRAN), and the portion of the IP-CAN 800 including the SGW 801, the PGW 803, and the MME 808 is referred to as an Evolved Packet Core (EPC). Although only a single eNB 810 is shown in FIG. 8, it should be understood that the EUTRAN may include any number of eNBs. An eNB may also be referred to as a small cell herein. Similarly, although only a single SGW, PGW and MME are shown in FIG. 8, it should be understood that the EPC may include any number of these core network elements.

The eNB 810 provides wireless resources and radio coverage for UEs. For the purpose of clarity, only one UE is illustrated in FIG. 8. However, any number of UEs may be connected (or attached) to the eNB 810. The eNB 810 is operatively coupled to the SGW 801 and the MME 808.

The SGW 801 routes and forwards user data packets, while also acting as the mobility anchor for the user plane during inter-eNB handovers of UEs. The SGW 801 also acts as the anchor for mobility between 3^{rd} Generation Partnership Project Long-Term Evolution (3GPP LTE) and other 3GPP technologies. For idle UEs, the SGW 801 terminates the downlink data path and triggers paging when downlink data arrives for UEs.

The PGW 803 provides connectivity between the UE 870 and the external packet data networks (e.g., the IP-PDN 8001) by being the point of entry/exit of traffic for the UE 810. As is known, a given UE may have simultaneous connectivity with more than one PGW for accessing multiple PDNs.

The PGW 803 also performs policy enforcement, packet filtering for UEs, charging support, lawful interception and packet screening, each of which are well-known functions. The PGW 803 also acts as the anchor for mobility between 3GPP and non-3GPP technologies, such as Worldwide Interoperability for Microwave Access (WiMAX) and 3^{rd} Generation Partnership Project 2 (3GPP2 (code division multiple access (CDMA) 1X and Enhanced Voice Data Optimized (EvDO)).

Still referring to FIG. 8, the eNB 810 is also operatively coupled to the MME 808. The MME 808 is the control-node for the EUTRAN, and is responsible for idle mode UE paging and tagging procedures including retransmissions. Idle mode may be a mode where the UE has not been used in a threshold amount of time of, for example, 10 minutes, 30 minutes or more. The MME 808 is also responsible for choosing a particular SGW for a UE during initial attachment of the UE to the network, and during intra-LTE handover involving Core Network (CN) node relocation. The MME 808 authenticates UEs by interacting with a Home Subscriber Server (HSS), which is not shown in FIG. 8. The network entity which hosts the methodology for real time small cells deployment optimization according to the principles of the invention may reside in the MME or other network node of the IP-CAN 800 or IP-SDN 8001.

Non Access Stratum (NAS) signaling terminates at the MME 808, and is responsible for generation and allocation of temporary identities for UEs. The MME 808 also checks the authorization of a UE to camp on a service provider's Public Land Mobile Network (PLMN), and enforces UE roaming restrictions. The MME 808 is the termination point in the network for ciphering/integrity protection for NAS signaling, and handles security key management.

The MME 808 also provides control plane functionality for mobility between LTE and 2G/3G access networks with the S3 interface from the SGSN (not shown) terminating at the MME 808. The MME 808 also terminates the Sha interface to the home HSS for roaming UEs.

FIG. 9 depicts a high-level block diagram of a computer suitable for use in performing the operations and methodology described herein. The computer 900 includes a processor 902 (e.g., a central processing unit (CPU) or other suitable processor(s)) and a memory 904 (e.g., random access memory (RAM), read only memory (ROM), and the like).

The computer 900 also may include a cooperating module/process 905. The cooperating process 905 can be loaded into memory 904 and executed by the processor 902 to implement functions as discussed herein and, thus, cooperating process 905 (including associated data structures) can be stored on a computer readable storage medium, e.g., RAM memory, magnetic or optical drive or diskette, and the like.

The computer 900 also may include one or more input/output devices 906 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 900 depicted in FIG. 9 provides a general architecture and functionality suitable for implementing functional elements described herein or portions of functional elements described herein. For example, the computer 900 provides a general architecture and functionality suitable for implementing one or more of a UE, an eNB, small cell, SGW, MME, PGW, network element, network entity which hosts the methodology for real time small cells deployment optimization according to the principles of the invention, and the like. For example, a processor of a MME can be configured to provide functional elements that implement in the small cell deployment optimization functionality discussed herein.

A person of skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of one or more of the methods described herein. The program storage devices may be non-transitory media, e.g., digital memories, magnetic storage media such as a magnetic disks or tapes, hard drives, or optically readable digital data storage media. In one or more embodiments, tangible medium excluding signals may include a set of instructions which when executed are operable to perform one or more of the descried methods. The provided embodiments are also intended to be embodied in computers programmed to perform said steps of methods described herein.

The method and apparatus according to the principles of the invention provides for optimal deployment of small cells in 3D environments to deliver a desirable QoE to users within a geographical area of interest for a given traffic distribution, while adapting the deployment to varying environmental and traffic conditions. The described solutions tackle the deployment of small cells in urban environments by taking into account the 3D environment characteristics, as well as the dynamics in traffic volume and QoE for the end users. One or more described solutions operate in real-time and determine on a continuous basis the suitable placement of the minimal number of small cells out of a 3D grid of candidate locations, while responding to traffic changes in an efficent and cost optimal way. Upon changes in system configurations, the one or more embodiments of the methodology swiftly initiate network configuration updates by pushing the updates down to the corresponding network elements via software updates. That is, the method/algorithm triggers a system reconfiguration, which may result in a change in serving sites and/or adjustment of critical parameters of the active sites (e.g. power levels, radiating patterns of the antenna . . . ).

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms ‘a’ or ‘an’, as used herein, are defined as one or more than one. The term “plurality”, as used herein, is defined as two or more than two. The term “another”, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms “including” and/or “having”, as used herein, are defined as comprising (i.e., open language). The term “coupled”, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein. As used herein, expressions such as “at least one of,” when preceding a list of elements, modify the entire list of elements and do not modify the individual elements of the list.

As used herein, the term “eNodeB” or “eNB” may be considered synonymous to, and may hereafter be occasionally referred to as a NodeB, base station, transceiver station, base transceiver station (BTS), small cell, etc., and describes a transceiver in communication with and providing wireless resources to users in a geographical coverage area. As discussed herein, eNBs may have all functionality associated with conventional, well-known base stations in addition to the capability and functionality to perform the methods discussed herein.

The term “user equipment” or “UE” as discussed herein, may be considered synonymous to, and may hereafter be occasionally referred to, as user, client, mobile unit, mobile station, mobile user, mobile, subscriber, user, remote station, access terminal, receiver, etc., and describes a remote user of wireless resources in a wireless communications network.

As discussed herein, uplink (or reverse link) transmissions refer to transmissions from user equipment (UE) to eNB (or network), whereas downlink (or forward link) transmissions refer to transmissions from eNB (or network) to UE.

According to example embodiments, the Packet Data Network Gateways (PGW), Serving Gateways (SGW), Mobility Management Entities (MME), UEs, eNBs, etc. may be (or include) hardware, firmware, hardware executing software or any combination thereof. Such hardware may include one or more Central Processing Units (CPUs), system-on-chip (SOC) devices, digital signal processors (DSPs), application-specific-integrated-circuits (ASICs), field programmable gate arrays (FPGAs) computers or the like configured as special purpose machines to perform the functions described herein as well as any other well-known functions of these elements. In at least some cases, CPUs, SOCs, DSPs, ASICs and FPGAs may generally be referred to as processing circuits, processors and/or microprocessors.

In more detail, for example, as discussed herein a MME, PGW and/or SGW may be any well-known gateway or other physical computer hardware system. The MME, PGW and/or SGW may include one or more processors, various interfaces, a computer readable medium, and (optionally) a display device. The one or more interfaces may be configured to transmit/receive (wireline or wireless sly) data signals via a data plane or interface to/from one or more other network elements (e.g., MME, PGW, SGW, eNBs, etc.); and to transmit/receive (wireline or wirelessly) controls signals via a control plane or interface to/from other network elements.

The MME, PGW and/or SGW may execute on one or more processors, various interfaces including one or more transmitters/receivers connected to one or more antennas, a computer readable medium, and (optionally) a display device. The one or more interfaces may be configured to transmit/receive (wireline and/or wireless sly) control signals via a control plane or interface.

The eNBs, as discussed herein, may also include one or more processors, various interfaces including one or more transmitters/receivers connected to one or more antennas, a computer readable medium, and (optionally) a display device. The one or more interfaces may be configured to transmit/receive (wireline and/or wirelessly) data or control signals via respective data and control planes or interfaces to/from one or more switches, gateways, MMEs, controllers, other eNBs, UEs, etc.

As discussed herein, the PGW, SGW, and MME may be collectively referred to as Evolved Packet Core network elements or entities (or core network elements or entities). The eNB may be referred to as a radio access network (RAN) element or entity.

Reference is made in detail to embodiments, examples of which are illustrated in the accompanying drawings, wherein like reference numerals refer to the like elements throughout. In this regard, the example embodiments may have different forms and should not be construed as being limited to the descriptions set forth herein. Accordingly, the example embodiments are merely described below, by referring to the figures, to explain example embodiments of the present description. Aspects of various embodiments are specified in the claims.

1. A method of small cell deployment, the method comprising:
in response to an initialization request or a performance alarm,
selecting, at a network entity, an initial number (N) of small cell candidate locations of one or more feasible small cell locations for small cells on a three dimensional grid of nodes representation of an area of interest;
determining, at the network entity, feasible M-sized small cell tuples having small cells that do not conflict with each other, wherein M has an initial value less than or equal to N;
computing, at the network entity, at least one performance Key Performance Indicator (KPI) for a subset of the feasible M-sized small cell tuples;
searching for a first tuple of the subset of the feasible M-sized small cell tuples, the at least one performance KPI of the first tuple satisfying one or more constraints on the small cell deployment;
when the searching for the first tuple does not indicate a feasible small cell deployment, incrementing , at the network entity, the initial value of M; and
when the searching for the first tuple indicates a feasible small cell deployment, preparing , at the network entity, a software patch configuration for one or more small cells of the feasible small cell deployment.

2. The method as claimed in claim 1, wherein the initial number (N) of small cell candidate locations is a predetermined number or one.

3. The method of claim 1, further comprising:
forming the three dimensional grid of nodes representation of the area of interest; and
determining the one or more feasible small cell locations on the three dimensional grid of nodes representation.

4. The method of claim 1, further comprising:
receiving traffic information updates; and
determining that the initialization request or the performance alarm was triggered.

5. The method as claimed in claim 1, further comprising:
transmitting the software patch configuration to a first small cell of the feasible small cell deployment.

6. The method as claimed in claim 1, wherein the software patch configuration indicates at least one of power level, beam shape, tilt or azimuth for a first small cell of the feasible small cell deployment.

7. The method as claimed in claim 1, further comprising:
configuring a first small cell of the feasible small cell deployment with one or more parameter values specified in the software patch configuration.

8. The method as claimed in claim 1, wherein the determining the feasible M-sized small cell tuples having small cells that do not conflict with each other comprises:
performing an exhaustive search algorithm, performing an algorithm to reduce a search space, or performing a binary integer program.

9. The method as claimed in claim 1, wherein the searching for the first tuple of the subset of the feasible M-sized small cell tuples comprises:
determining a plurality of tuples of the subset of the feasible M-sized small cell tuples which satisfy the one or more constraints on the small cell deployment; and
selecting as the first tuple the one of the plurality of tuples of the subset of the feasible M-sized small cell tuples having best performance KPIs.

10. The method as claimed in claim 1, wherein the at least one performance KPI is at least one of the group consisting of cell edge Signal to Interference and Noise Ratio (SINR), average SINR, user cell edge throughput, and average user throughput.

11. A device comprising a processor and an associated memory, the processor configured to:
in response to an initialization request or a performance alarm, select an initial number (N) of small cell candidate locations of one or more feasible small cell locations for small cells on a three dimensional grid of nodes representation of an area of interest;
determine feasible M-sized small cell tuples having small cells that do not conflict with each other, wherein M has an initial value less than or equal to N;
compute at least one performance Key Performance Indicator (KPI) for a subset of the feasible M-sized small cell tuples;
perform a search for a first tuple of the subset of the feasible M-sized small cell tuples, the at least one performance KPI of the first tuple satisfying one or more constraints on the small cell deployment;
increment the initial value of M when the search for the first tuple does not indicate a feasible small cell deployment; and
prepare a software patch configuration for one or more small cells of the feasible small cell deployment when the search for the first tuple indicates a feasible small cell deployment.

12. The apparatus as claimed in claim 11, wherein the initial number (N) of small cell candidate locations is a predetermined number or one.

13. The apparatus of claim 11, wherein the processor is configured to:
form the three dimensional grid of nodes representation of the area of interest; and
determine the one or more feasible small cell locations on the three dimensional grid of nodes representation.

14. The apparatus of claim 11, wherein the processor is configured to:
receive traffic information updates; and
determine whether the initialization request or the performance alarm was triggered.

15. The apparatus of claim 11, wherein the processor is configured to:
transmit the software patch configuration to a first small cell of the feasible small cell deployment.

16. The apparatus as claimed in claim 11, wherein the software patch configuration indicates at least one of power level, beam shape, tilt or azimuth for a first small cell of the feasible small cell deployment.

17. The apparatus of claim 11, wherein the processor is configured to:
instruct a first small cell of the feasible small cell deployment to implement one or more parameter values specified in the software patch configuration.

18. The apparatus as claimed in claim 11, wherein to determine the feasible M-sized small cell tuples having small cells that do not conflict with each other, the processor is configured to perform an exhaustive search algorithm.

19. The apparatus as claimed in claim 11, wherein to determine the feasible M-sized small cell tuples having small cells that do not conflict with each other, the processor is configured to perform an algorithm to reduce a search space.

20. The apparatus as claimed in claim 11, wherein to determine the feasible M-sized small cell tuples having small cells that do not conflict with each other, the processor is configured to perform a binary integer program.

21. The apparatus as claimed in claim 11, wherein to search for the first tuple of the subset of the feasible M-sized small cell tuples, the processor is configured to:
determine a plurality of tuples of the subset of the feasible M-sized small cell tuples which satisfy the one or more constraints on the small cell deployment; and
select as the first tuple the one of the plurality of tuples of the subset of the feasible M-sized small cell tuples having best performance KPIs.

22. The apparatus as claimed in claim 11, wherein the at least one performance KPI is at least one of the group consisting of cell edge Signal to Interference and Noise Ratio (SINR), average SINR, user cell edge throughput, and average user throughput.
